(19) United States
(12) Patent Application Publication
(10) Pub. No.: US 2007/0176403 A1
(43) Pub. Date: Aug. 2, 2007

(54) Air adjustable seat

(76) Inventor: Dennis Calderone, Whittier, CA (US)

Correspondence Address: AVERILL & VARN, 8244 PAINTER AVE., WHITTIER, CA, 90602, US

(21) Appl. No.: 11/701,908

(22) Filed: Feb. 1, 2007

Related U.S. Application Data
(60) Provisional application No. 60/764,483, filed on Feb. 1, 2006.

(51) Int. Cl. B60R 21/16

(52) U.S. Cl. 280/735

(57) ABSTRACT

An improved air adjustable seat includes an air pump, at least one air bag, and an air switch for adjusting seat height. The air pump is preferably controlled by a pressure switch. The air pump is connected to the air switch through a first air line, and the air switch is connected to the air bags through a second air line. The air pump is controlled by the pressure switch to maintain a minimum pressure in the first line. The air switch has three positions, fill, hold, and release. In the fill position, high pressure air from the air pump is passed to the air bags. In the hold position, the first line is blocked, and air in the air bags is held to maintain seat height. In the release position, the first line is blocked, and air is released from the air bags to lower the seat.

The present application claims the benefit of U.S. Provisional Application Ser. No. 60/764,483, filed Feb. 1, 2006, which application is incorporated herein by reference.

### BACKGROUND OF THE INVENTION

The present invention relates to air adjustable devices and in particular to an air adjustable motorcycle seat.

The height of motorcycle seats is important to both comfort and safety. When at rest, a rider must generally support the motorcycle using the rider's legs. When the seat is too low, the rider's legs may be bent, and provide a weak position. When the seat is too high, the rider may have to either lean the motorcycle, or point the rider's feet to reach the ground. Leaning the motorcycle may result in slipping and either injury to the rider or damage to the motorcycle. Pointing the feet may result in discomfort.

The Rigidaire Adjustable Pneumatic Seating System air adjustable seat developed by Paul Cox and described in US Patent Publication No. 2005/0168018 uses an air pump and inflatable air bags to adjust seat height. While the basic approach of using an air adjustable system works well, the wiring and electrical switch used to control the Rigidaire Adjustable Pneumatic Seating System air adjustable seat is susceptible to damage from vibrations, moisture, etc. Additionally, the system disclosed by Cox requires a exhaust solenoid to empty the air bags. The '018 patent Application is herein incorporated by reference.

There is thus a need for an air adjustable seat which does not include an electric switch and unnecessary wiring.

### BRIEF SUMMARY OF THE INVENTION

The present invention addresses the above and other needs by providing an improved air adjustable seat which includes an air pump, air bags, and an air switch for adjusting seat height. The air pump is preferably controlled by a pressure switch. The air pump is connected to the air switch through a first air line, and the air switch is connected to the air bags through a second air line. The air pump is controlled by the pressure switch to maintain a minimum pressure in the first line. The air switch has three positions, fill, hold, and release. In the fill position, high pressure air from the air pump is passed to the air bags. In the hold position, the first line is blocked, and air in the air bags is held to maintain seat height. In the release position, the first line is blocked, and air is released from the air bags to lower the seat.

### BRIEF DESCRIPTION OF THE SEVERAL VIEWS OF THE DRAWINGS

The above and other aspects, features and advantages of the present invention will be more apparent from the following more particular description thereof, presented in conjunction with the following drawings wherein:

FIG. 1 is a motorcycle with a fixed prior art seat.

FIG. 2A is a side view of an air adjustable seat according to the present invention.

FIG. 2B is a rear view of the air adjustable seat.

FIG. 3A shows the air adjustable seat in a lowered position.

FIG. 3B shows the air adjustable seat in a raised position.

FIG. 4 shows the air adjustable seat according to the present invention with bumpers to prevent metal to metal contact between the seat and motorcycle frame.

FIG. 5 shows the air adjustable seat according to the present invention with a damper to smooth the motion between the seat and motorcycle frame.

FIG. 6A shows a first seat mounting for the air adjustable seat.

FIG. 6B shows a second seat mounting for the air adjustable seat.

FIG. 6C shows a detailed view of a vertical bracket and bolt used for seat mounting.

FIG. 6D shows a detailed cross-sectional view of the vertical bracket and bolt used for seat mounting.

FIG. 6E is a cross-sectional view taken along line 6E-6E of FIG. 6A of attachment details of the first seat mounting of the air bag of the air adjustable seat.

FIG. 6F is a cross-sectional view taken along line 6F-6F of FIG. 6B of attachment details of the second seat mounting of the air bag of the air adjustable seat.

FIG. 7A shows a side view of a pivoting front bracket for the air adjustable seat.

FIG. 7B shows a rear view of the pivoting front bracket for the air adjustable seat.

A cross-sectional view of the pivoting front bracket taken along line 7C-7C of FIG. 7A is shown in FIG. 7C.

FIG. 8A is a functional diagram of a first embodiment of the air adjustable seat.

FIG. 8B is a functional diagram of a second embodiment of the air adjustable seat.

FIG. 8C is a functional diagram of a third embodiment of the air adjustable seat.

FIG. 8D is a functional diagram of a fourth embodiment of the air adjustable seat.

FIG. 8E is a functional diagram of a fifth embodiment of the air adjustable seat.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

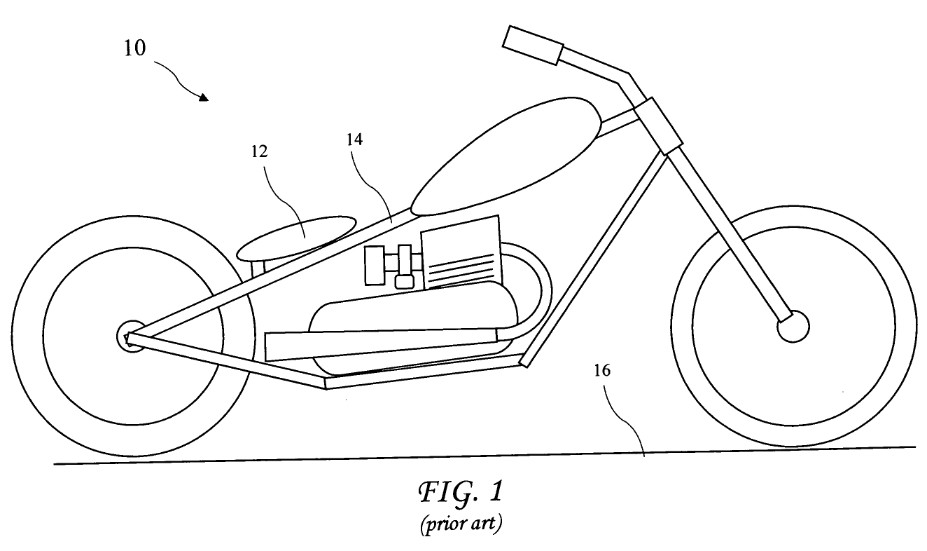

A motorcycle 10 with a fixed prior art seat 12 is shown in FIG. 1. The seat 12 is mounted to the frame 14 using a fixed mounting. While some known mountings may be adjusted, such adjustment may be difficult and time consuming. Because the seat 12 is fixed, the distance between the seat 12 and the ground 16 may result in an uncomfortable or even unsafe situation when a rider must support the motorcycle 10.

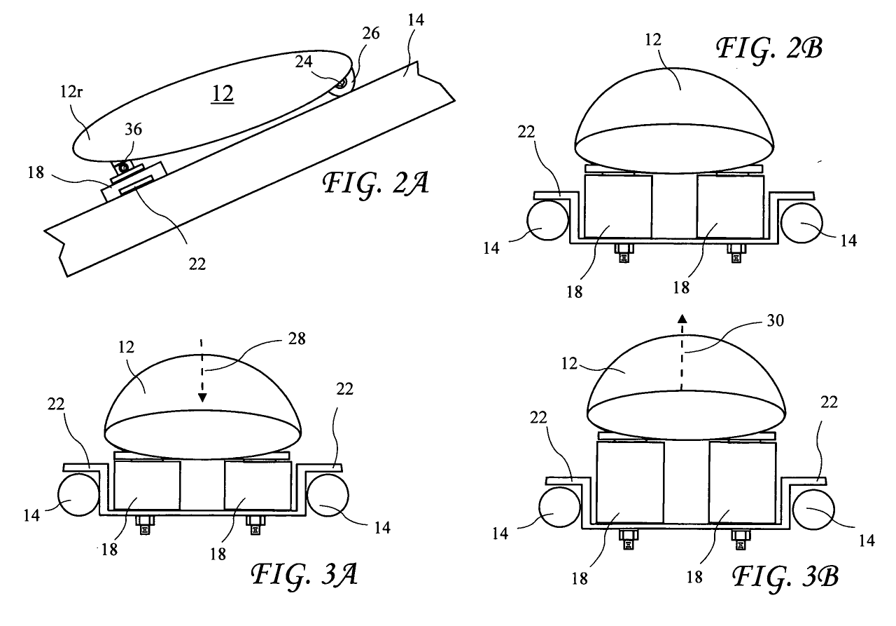

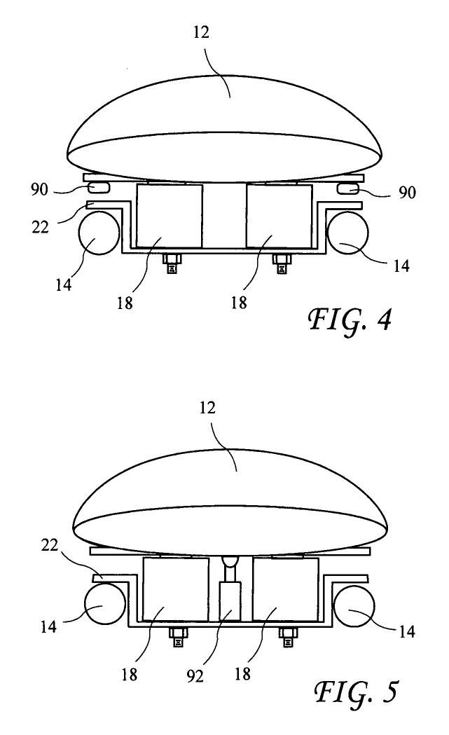

A side view of an air adjustable seat according to the present invention is shown in FIG. 2A, and a rear view of the air adjustable seat is shown in FIG. 2B. A seat rear 12r of the air adjustable seat is supported by air bags 18 which are mounted to the frame 14 by a rear bracket 22. The front of the air adjustable seat is mounted at a pivot 24 and bracket 26. A pressure switch 20 (not shown) is preferably attached to an air pump 54 (not shown) preferably residing proximal to the seat 12. The air adjustable seat is shown in a lowered position in FIG. 3A and in a raised position in FIG. 3B. Such adjustment of seat height allows a rider to comfortably and safely support a stationary motorcycle.

The air adjustable seat 12 according to the present invention is shown with bumpers 90 to prevent metal to metal contact between the seat 12 and motorcycle frame 14. The bumpers 90 may be solid rubber or may be air filled, and may be located at any location where the bumper 90 prevents metal to metal contact during use of the seat 12. The bumpers 90 may further limit the downward motion of the seat 12 to prevent or reduce damage to the air bags 18 from the seat 12 bottoming out against the motorcycle frame 14. The bumpers 90 preferably comprise two bumpers 90 on opposite sides of the seat 12 residing between the seat and the rear bracket 22. Alternatively, a single bumper may be centered between the air bags 18.

The air adjustable seat 12 according to the present invention is shown in FIG. 5 with a damper 92 to smooth the motion between the seat 12 and motorcycle frame 14. The damper 92 may be a single centered damper between the air bags 18, or two dampers may be used. Examples of suitable shock absorbers are a Model c16-16271 made by Suspa in Grand Rapids, Mich. and a model number 6309292 40n made by Newflyer.

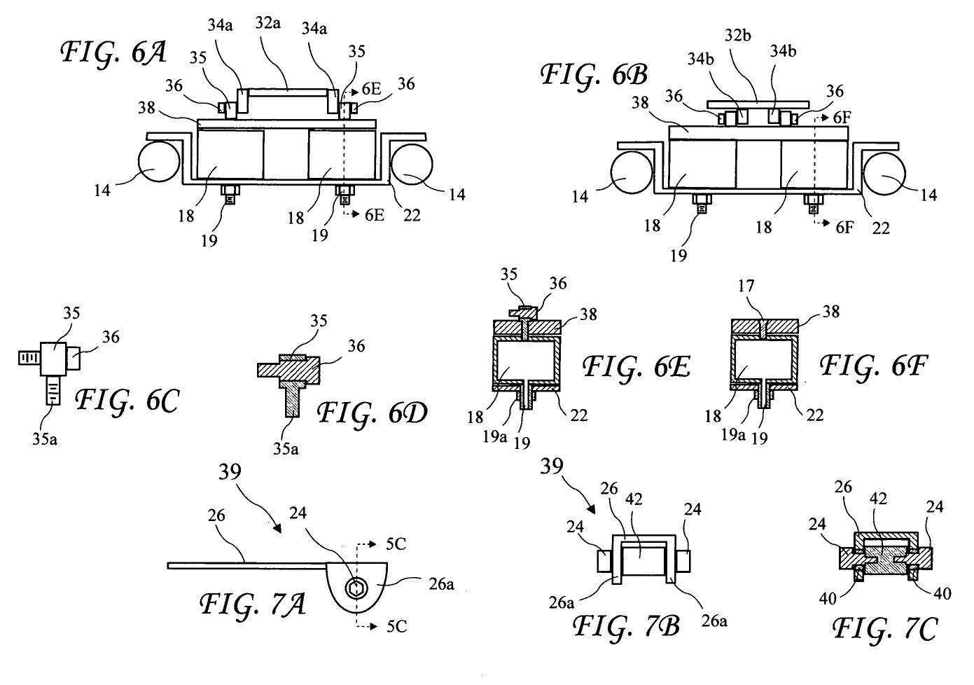

A first rear seat mounting for the air adjustable seat is shown in FIG. 6A. The first seat mounting comprises a first horizontal member 32a which attaches to the seat 12 and resides between first upper vertical members 34a. The members 34a are rotatably connected to lower vertical brackets 35 by bolts 36 to reduce or prevent binding when the seat is raised or lowered. The use of shoulder bolts allows the members 34a to be firmly attached to the studs 35 without binding. The brackets 35 are connected to a lower horizontal bracket 38 which couples the air bags 18, and the brackets 35 and 38. Preferably, the bracket 35 includes a threaded portion which runs through the horizontal bracket 38 and into the air bags 18.

A second seat mounting for the air adjustable seat is shown in FIG. 6B. The second seat mounting comprises a second upper horizontal member 32b attached on top of second upper vertical members 34b. The members 34b are connected to the bracket 38 and air bags 18 in a manner similar to the first seat mounting.

A detailed view of the vertical bracket 35 and bolt 36 used for seat mounting is shown in FIG. 6C and a detailed cross-sectional view of the vertical bracket 35 and bolt 36 is shown in FIG. 6D. The vertical bracket 35 includes a threaded portion 35a which may extend through the lower horizontal bracket 38 and screw into the air bag 18 as in the embodiment of FIG. 6A, or may screw into the lower horizontal bracket 38 as in the embodiment of FIG. 6B. The bolt 36 is preferably a shoulder bolt to allow free motion of the air adjustable seat.

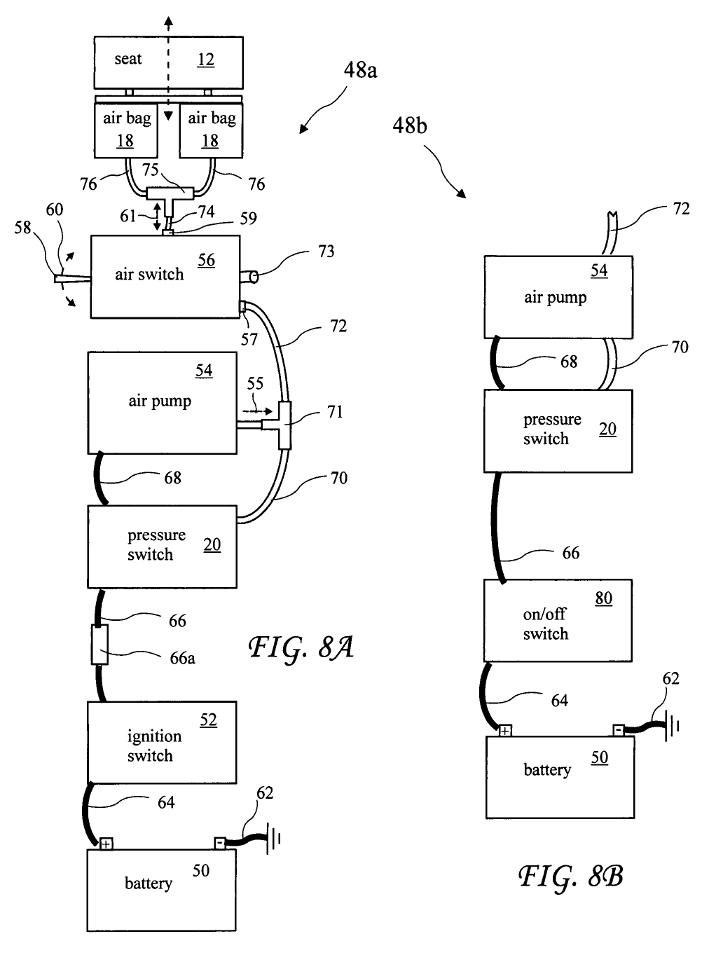

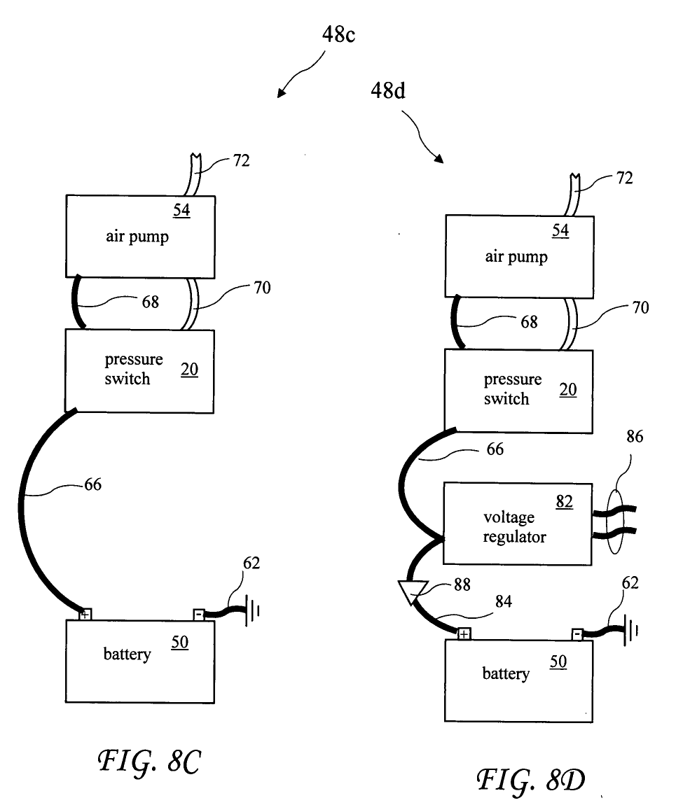

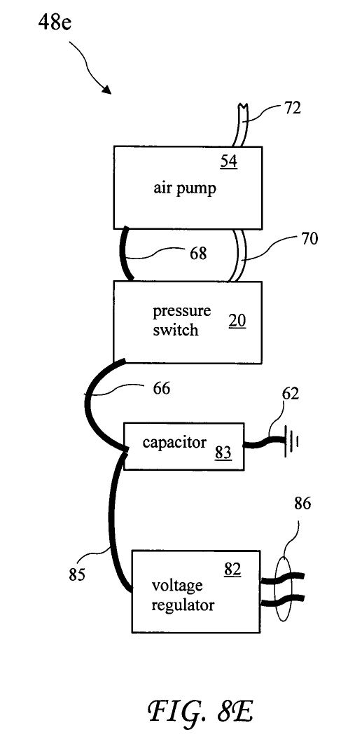

A cross-sectional view of attachment details of the first seat mounting of the air bag 18 of the air adjustable seat taken along line 6E-6E of FIG. 6A is shown in FIG. 6E. The threaded portion of the vertical bracket 35 extends through the lower horizontal bracket 38 and is threaded into the air bag 18. A threaded port 19 extends downward from the air bag 18, through the rear bracket 22, and is held by a lower nut 19a. Air lines 76 (see FIG. 8A) connect to the threaded port 19 to provide a flow of air to the air bags 18.

A cross-sectional view of attachment details of the second seat mounting of the air bag 18 of the air adjustable seat taken along line 6F-6F of FIG. 6B are shown in FIG. 6F. The air bag 18 is attached to the lower horizontal bracket 38 by a recessed screw 17. FIG. 6F is otherwise similar to the first seat mounting shown in FIG. 6E.

A side view of a pivoting front bracket 39 for the air adjustable seat is shown in FIG. 7A and a rear view of a pivoting front bracket 39 for the air adjustable seat is shown in FIG. 7B. The pivoting front bracket 39 includes a frame piece 42 for attaching (e.g., welding) to the frame, a pivoting arm 26, and shoulder bolts 24 connecting the pivoting arm 26 to the frame piece 42. The pivoting arm 26 is preferably made from 3/16″ stainless steel plate with ears 26a bent at 90 degrees to cooperate with the frame piece 42.

A cross-sectional view of the pivoting front bracket 39 taken along line 7C-7C of FIG. 7A is shown in FIG. 7C. The pivoting arm 26 is preferably attached to the frame piece 42 by shoulder bolts 24. The pivoting arm 26 preferably includes brass bushings 40 for cooperation with the shoulder bolts 24, which shoulder bolts are stainless steel shoulder bolts.

A functional diagram of a first embodiment 48a of the air adjustable seat is shown in FIG. 8A. A battery 50 is connected by a ground cable 62 to ground, and by a positive cable 64 to an ignition switch 52. When in an “ON” position, the ignition switch 52 electrically connects the battery 52 to the pressure switch 20 by a pressure switch lead 66, thus providing power to the pressure switch 20 when the ignition switch 52 is in an ON position. A fuze 66a is preferably connected in series in the cable 66. The pressure switch 20 is connected to an air pump 54 by an air pump lead 68 to provide power to the air pump 54. The air pump 54 may be directly grounded by it's attachment to the motorcycle frame, or have a separate ground lead.

The air pump 54 provides a first (or compressed) air flow 55. A “T” 71 is connected to an air outlet of the air pump 54, and a third air line 70 is connected between the “T” 71 and the pressure switch 20 to provide the air flow 55 from the air pump to the pressure switch 20. The pressure switch 20 turns the air pump 54 on whenever the air pressure in the third line 70 drops below a minimum pressure Pmin, for example, 50 psi. The pressure switch 20 turns the air pump 54 off whenever the air pressure in the third line 70 rises above a maximum pressure Pmax, for example 60 psi. In other instances, the pressures Pmin and Pmax may for example be 120 psi and 130 psi respectively for a heavier rider. The values of Pmin and Pmax are selected to maintain the pressure in the “T” 71 within useful bounds, while not cycling the air pump 54 on and off overly often. The pressure switch 20 is preferably mounted or attached to the air pump 54, but may be a separate element, and the pressure switch 20 and may be directly attached to the “T” 71.

The air pump 54 is connected to an air switch 56 at an inlet port 57 by a first air line 72 connected to the “T” 71 to provide the air flow 55 to the air switch 56. A switched port 59 on the air switch 56 is connected to the air bags 18 by a second air line 74 through a second “T” 75 and fourth air lines 76, to provide and to receive an air bag air flow 61 to and from the air bags 18. The air switch 56 further includes an open air port 73.

The air switch 56 includes a switch 58 for controlling a flow of air through the air switch 56. In a center (or neutral) position, the air lines 72 and 74 (or ports 57 and 59) are blocked and no air flows into or out of the air bags 18 and no air is received from the air pump 54. In a fill position (preferably up), the air lines 72 and 74 (or ports 57 and 59) are connected, and air flows through the air switch 56 from the air pump 54 into the air bags 18, thus raising the seat 12. In an empty position (preferably down) the air line 72 (port 57) is blocked, and the air line 74 (or port 59) is connected to the port 73 allowing air to flow out of the air bags 18 through the port 73 to lower the seat 12. The air switch 56 preferably includes a ball check valve (or similar one way valve) between the inlet port 57 and the outlet port 59 to prevent a flow of air from the air bags 18 to the air pump 54.

The pressure switch 20 is preferably a Nason model/part number SM-2A-60/AT, SM-2B-60/AT, SM-2C-60/AT, MM-2A-60/AT, MM-2B-60/AT, MM-2C-60/AT, LM-2A-60/AT, LM-2B-60/AT, or LM-2C-60/AT, 60 psi normally closed pressure switch, or a similar switch. The pressure switch may also be a variable/adjustable switch up to 130 psi, or may be fixed at a lower psi.

The air switch 56 is preferably a GT Development height control paddle switch model/part number 3013-1 or a similar air switch. The 3013-1 is a push to connect device, but an air switch with other connection types may be used without departing from the present invention. For example, the air control may also include barbed connections. The air switch may also include a rocker type switch, a toggle type switch, or a push pull switch. Other suitable air switches include the part number 9904-008616-001 made by USSC in King of Prussia, Pa.

The air bag 18 preferably has a stroke between approximately 0.5 inches and approximately three inches, and more preferably approximately two inches. The air bag 18 preferably has a diameter between approximately two inches and approximately three inches, and more preferably approximately 2¾ inches. A suitable air bag is a Goodyear super-cushion mini lobe (air bag) part number 1S3-013 or a similar air bag. There are preferably two air bags, but a single large air bag may be used if necessary due to space limitation, and additional support may be required with a single air bag. Other suitable air bags include models ASNC2-1-1, ASNC6-1-1, ASNC6-1-1, ASNC6-3-1, and ASNC44-1 made by Numatics in Highland, Mich. and models 7002, 1M1A-0, 1M1A-1, and 2M2A made by Firestone in Indianapolis, Ind.

The air pump 54 preferably is an approximately 60 PSI to approximately 130 PSI twelve volt air pump. Examples of suitable air pumps include: air pump model/part number 115ADC56/12 and model/part number 125ADC56/12 made by a Rietschle Thomas in Schopfheim, Germany; a model 100c made by Viair in Irvine, Calif.;

A functional diagram of a second embodiment 48b of the air adjustable seat is shown in FIG. 8B. In the embodiment 48b an on/off switch 80 is connected between the battery 50 and the pressure switch 20, thereby eliminating the ignition switch 52 from the system. The embodiment 48b is otherwise similar to the first embodiment 48a.

A functional diagram of a third embodiment 48c of the air adjustable seat is shown in FIG. 8C. In the third embodiment 48c, the pressure switch is connected directly to the positive pole of the battery 50. The embodiment 48c is otherwise similar to the first embodiment 48a.

A functional diagram of a fourth embodiment 48d of the air adjustable seat is shown in FIG. 8D. The pressure switch 20 is connected to the charging terminal of a voltage regulator 82 by the cable 66, and a diode 88 resides between the charging terminal of the voltage regulator and the positive terminal of the battery 50 on a cable 84 to prevent discharge of the battery when the motor is not running. The embodiment 48d is otherwise similar to the first embodiment 48a.

A functional diagram of a fifth embodiment 48e of the air adjustable seat is shown in FIG. 8E. The pressure switch 20 is connected to a positive terminal of a capacitor 83 by the cable 66, and the capacitor 83 is connected to the voltage regulator 82 by a cable 85. The embodiment 48d is otherwise similar to the first embodiment 48a.

Ground wires are not shown in every instance, and in some cases the device, for example the air pump, may be grounded by a ground wire or by the device case, frame, etc.

While the invention herein disclosed has been described by means of specific embodiments and applications thereof, numerous modifications and variations could be made thereto by those skilled in the art without departing from the scope of the invention set forth in the claims.

I claim:

1. An air adjustable motorcycle seat comprising:
an electrical power source;
a pressure switch electrically connected to the electrical power source for receiving electrical power;
an air pump electrically connected to the pressure switch for receiving electrical power switched by the pressure switch and in fluid communication with the pressure switch for providing a first air flow to the pressure switch;
an air switch having an inlet port, a switched port, and an open air port, the air switch in switchable fluid communication with the air pump through the inlet port for receiving the first air flow from the air pump;
at least one air bag in switchable fluid communication with the air pump through the switched port, the switched port for receiving and sending a second air flow; and
a seat rear attached to the air bag, wherein the seat rear may be raised by providing the second air flow to the at least one air bag and may be lowered by removing the second air flow from the at least one air bag.

2. The air adjustable motorcycle seat of claim 1, wherein the air switch has:
a fill position wherein the inlet port is in fluid communication with the switched port to provide the second air flow to the at least one air bag to raise the seat;
a neutral position wherein the inlet port and the switched port are blocked; and
an empty position wherein the inlet port is blocked and the switched port is in fluid communication with the open air port to provide the second air flow from the at least one air bag to the open air port to lower the seat.

3. The air adjustable motorcycle seat of claim 2, wherein the at least one air bag comprises two air bags residing under the seat rear of the motorcycle seat.

4. The air adjustable motorcycle seat of claim 3, wherein the two air bags are attached to the motorcycle seat using a rotatable connection to reduce or prevent binding when the seat is raised or lowered.

5. The air adjustable motorcycle seat of claim 4, wherein the two air bags are attached to the motorcycle seat using a rotatable connection including shoulder bolts to reduce or prevent binding when the seat is raised or lowered.

6. The air adjustable motorcycle seat of claim 2, wherein the two air bags have a stroke between approximately 0.5 inches and approximately three inches.

7. The air adjustable motorcycle seat of claim 6, wherein the two air bags have a stroke of approximately two inches.

8. The air adjustable motorcycle seat of claim 2, wherein the two air bags have a diameter between approximately two inches and approximately three inches.

9. The air adjustable motorcycle seat of claim 8, wherein the two air bags have a diameter of approximately 2¾ inches.

10. The air adjustable motorcycle seat of claim 2, wherein the two air bags operate at a pressure of up to between 60 PSI and 120 PSI.

11. The air adjustable motorcycle seat of claim 2, wherein at least one rubber bumper resides under the motorcycle seat configured to prevent metal to metal contact when the seat is lowered.

12. The air adjustable motorcycle seat of claim 2, wherein at least one damper resides under the motorcycle seat configured to dampen upward and downward motion of the seat.

13. The air adjustable motorcycle seat of claim 1, wherein the electric power source comprises an ignition switch connected electrically serially between a battery and the pressure switch.

14. The air adjustable motorcycle seat of claim 1, wherein the electric power source comprises an on/off switch connected electrically serially between a battery and the pressure switch.

15. The air adjustable motorcycle seat of claim 7, wherein the pressure switch is connected to a charging terminal of the voltage regulator, and a diode resides between the charging terminal of the voltage regulator and the positive terminal of a battery to prevent discharge of the battery when the motor is not running.

16. An air adjustable motorcycle seat comprising:
an electrical power source;
a pressure switch electrically connected to the electrical power source for receiving electrical power;
an air pump electrically connected to the pressure switch for receiving electrical power switched by the pressure switch and in fluid communication with the pressure switch for providing a first air flow to the pressure switch;
at least one air bag supporting the motorcycle seat;
an air switch having:
an inlet port in fluid communication with the air pump ro receive a first air flow from the air pump;
a switched port in fluid communication with the at least one air bag to send and receive a second air flow to and from the at least one air bag;
an open air port for releasing air;
a fill position wherein the inlet port is in fluid communication with the switched port to provide the second air flow to the at least one air bag to raise the seat;
a neutral position wherein the inlet port and the switched port are blocked to hold the seat; and
an empty position wherein the inlet port is blocked and the switched port is in fluid communication with the open air port to provide the second air flow from the at least one air bag to the open air port to lower the seat.

17. An air adjustable motorcycle seat comprising:
an electrical power source;
a pressure switch electrically connected to the electrical power source for receiving electrical power;
an air pump electrically connected to the pressure switch for receiving electrical power switched by the pressure switch and in fluid communication with the pressure switch for providing a first air flow to the pressure switch;
two air bags supporting a rear of the motorcycle seat;
an air switch having:
an inlet port in fluid communication with the air pump ro receive a first air flow from the air pump;
a switched port in fluid communication with the two air bags to send and receive a second air flow to and from the at least one air bag;
an open air port for releasing air;
a fill position wherein the inlet port is in fluid communication with the switched port to provide the second air flow to the two air bags to raise the rear of the motorcycle seat;
a neutral position wherein the inlet port and the switched port are blocked to hold the rear of the motorcycle seat; and
an empty position wherein the inlet port is blocked and the switched port is in fluid communication with the open air port to provide the second air flow from the two air bags to the open air port to lower the rear of the motorcycle seat.
